(19) United States
(12) Patent Application Publication
(10) Pub. No.: US 2016/0361835 A1
(43) Pub. Date: Dec. 15, 2016

(54) DRUM ROTATION DETECTION SYSTEM

(71) Applicant: GLOBAL TRAX ONE, INC., Houston, TX (US)

(72) Inventors: Anurudha Kulatunge, Houston, TX (US); Mihindu Paul, Mirigama (LK); Brij Walia, Seabrook, TX (US); Eric Walia, Seabrook, TX (US)

(73) Assignee: GLOBAL TRAX ONE, INC., Houston, TX (US)

(21) Appl. No.: 15/183,588

(22) Filed: Jun. 15, 2016

Related U.S. Application Data
(60) Provisional application No. 62/175,764, filed on Jun. 15, 2015.

(51) Int. Cl. B28C 5/42; H04N 5/225; G06T 7/00; G06T 7/20

(52) U.S. Cl. CPC B28C 5/422; G06T 7/204; H04N 5/2253; G06T 7/0044; H04N 5/2252; G06T 2207/30252; G06T 2207/10016

(57) ABSTRACT

A system for determining the rotational direction of a ready mix concrete truck drum can be used to accurately determine the time interval between when a batch of concrete is loaded into a ready mix truck and when it is discharged. This time interval is critical to the overall quality of the concrete. The present invention comprises a camera, a computing platform, and software that runs on the computing platform that can interpret the visual data captured by the camera and determine the rotational direction of the ready mix drum. This rotational direction data can then be used to determine the time interval from when the concrete is loaded on the truck and when the concrete is discharged. This time interval directly relates to the quality of the concrete.

### CROSS-REFERENCE TO RELATED APPLICATION

This application claims the benefit of U.S. Provisional Application Ser. No. 62/175,764 filed Jun. 15, 2015 entitled “Drum Rotation Detection System,” and is incorporated by reference herein for all purposes.

### FIELD

The invention disclosed herein is a system and method for determining the direction of drum rotation for ready mix concrete delivery trucks and the timing of the discharge of concrete from ready mix concrete delivery trucks.

### BACKGROUND AND SUMMARY

Ready mix delivery trucks (concrete delivery trucks) are the work horses in the ready mix industry delivering concrete from the batch plants, where the mix to make concrete is loaded on to the truck, to the construction site. Once at the construction site, the concrete may be pumped through an external pumping system or may be simply discharged (off loaded) directly to the location that needs the concrete.

In order to guarantee the quality and structural strength of a building, the concrete that is delivered must adhere to rigorous standards. The quality of the concrete is correlated to the amount of time the concrete has been inside the drum and the amount of water that has been added to ensure that the concrete is easy to pour. In order to ensure that customers receive the concrete in adherence with the standards required for a particular job, ready mix companies locate their batch plants strategically in order to reach the construction sites within the shortest possible time. External factors also contribute to the quality of the ready mix. Conditions such as roadway congestion, heat, and the weather conditions in general can impact the quality of ready mix concrete.

As one can see from the above description, the concrete is extremely susceptible to external factors that have a direct bearing to the quality of the concrete. The quality of the concrete has a direct bearing on the structural strength of the building. A building that has been built with compromised material can crack and collapse, threatening the lives of people and destroying any important items housed within the building.

The quality of the concrete is a key component when building a building. The quality of the concrete relates to the time interval between when the concrete mix is loaded onto the ready mix truck and when the concrete is delivered to the construction site. If the concrete has been sitting in the ready mix truck for too long, it may exceed the standards, and the customer will reject the load.

Most ready mix trucks contain a set of blades or fins in the interior of the mixing drum. When the drum is rotated one direction, the truck may be loaded and the concrete mixed. When the drum is rotated the other direction, the mixed concreted is discharged or unloaded. The ready mix companies keep records of when the ready mix concrete is discharged at a particular location. To prevent any future lawsuits due to substandard ready mix, the ready mix companies use several methods to record the time of discharge. This information can be used, along with the time the concrete was loaded onto the ready mix truck, to determine how long the ready mix has been in a ready mix truck drum. This time period is a factor in determining if the ready mix complies with the governing standards.

The most basic and error prone technique used to address this issue is to have the ready mix driver record the time of discharge manually. The customer may additionally assign a person to sign off on the time of discharge, thus providing a validated mechanism to record the discharge event. These records, which rely 100% on human input, are considered quite error prone.

Several ready mix truck manufacturers have developed their own proprietary drum rotation sensor solutions, such as the solution disclosed in U.S. Pat. No. 7,722,243 B2 by Schumacher et al. This solution relies on the hydraulics of the drum rotation drive to determine the direction of rotation. Although this is an accurate solution, it is only applicable when the ready mix truck is manufactured by a particular company. There are many other ready mix truck manufacturers; hence the solution is not universally applicable.

With proprietary solutions, a ready mix truck operator will face a daunting task to keep the fleet well maintained because different manufacturers will each provide their own solutions. Furthermore, proprietary solutions also mandate that the ready mix fleet operator must purchase that particular truck manufacturer's solution. What happens to a truck before that particular truck is purchased is another unanswered question which may impact the availability of some drum rotation detection solutions. Due to these basic issues, proprietary solutions are often not applicable across an entire fleet of ready mix trucks.

An alternative prior art solution involves placing magnets on the drum. This system also requires a sensor that has been developed by Trimble Corporation and is covered under several patents (e.g., U.S. Pat. No. 6,611,755). The sensor detects the movement of the magnets, which informs the speed and direction of drum rotation. While this is the most common solution currently in use, it is not ideal considering the standard practices of the ready mix industry.

In the Trimble solution, the magnets are bolted to the drum. These magnets are then exposed to acids that are used to clean the drums when concrete splashes onto the drum. The exposure to acid over a period of time destroys the magnets. The ready mix company has to replace the magnets that have malfunctioned, and this will impact the productivity of the ready mix truck.

Furthermore, the sensor that detects the magnets gets exposed to acid as well. The sensor degrades over a period of time and eventually must be replaced by the ready mix company. Both the ready mix truck and the drum itself vibrate due to the motion of the drum. The drum and the chassis vibration often cause the sensor to become misaligned. When the sensor is not in proper alignment, the rotation of the drum is not detected.

The average ready mix truck operator estimates that the sensor must be adjusted, repaired, or replaced at least three times per year. This repair requires the truck to be out of service and reduces the productivity of the truck for that period of time.

The Trimble solution involving magnets and sensors is a potentially universal solution, but the problems associated with cleaning acid and harsh chemicals makes that solution very expensive to maintain. The precision required to align the sensor or to rerun the cables from the drum sensor to the control box consumes significant time and cost.

A ready mix truck may work for 12-15 hours per day or more. When a sensor malfunctions, the loss of a truck for a few hours can cause significant financial harm to the operator.

An aspect of the invention is to provide a solution for determining the direction of rotation of a ready mix truck drum that is protected from the harsh conditions and chemicals associated with ready mix trucks.

Another aspect of the invention is to determine the time interval between the loading and discharge of a ready mix truck drum.

An additional aspect of the invention is to provide a solution for ready mix truck operators to determine if concrete complies with the governing regulations.

A system and method of determining the direction of rotation of a ready mix truck drum is disclosed. The system described herein comprises a camera, a computing platform optimized for image processing, and software that runs on the computing platform to process the images and compare the position of the drum in one image against the previous image to determine the direction of rotation of the drum.

The present invention addresses the most common issues faced by the ready mix delivery truck operators, determining the direction of rotation in a way that is both reliable and easy to maintain. The present invention operates with little or no exposure to the harsh environmental conditions and chemicals associated with ready mix delivery trucks. The invention is mounted inside the interior of a ready mix truck's cabin on the rear window of the ready mix truck. This position provides the camera with a clear view of the drum without exposing any of the components to the exterior conditions.

### BRIEF DESCRIPTION OF THE DRAWINGS

FIG. 1 is a block diagram showing the components of the visual direction detection system 100 and how the system 100 can be attached to the back window 350 of a vehicle.

FIG. 2 is a flow diagram of a technique provided by the system 100 for determining the direction and speed of rotation of a ready mix truck drum 400.

FIG. 3 is a depiction of the various potential visible marks that may be man-made 440 or occur due to natural wear and tear 420 on a ready mix truck drum 400.

FIG. 4 shows multiple examples of where the camera unit 200 can be mounted on the rear window 350 of the ready mix truck cabin.

FIGS. 5A-5C show a series of images of a ready mix truck drum 400 with visible man-made markings 440, visible wear and tear 420, and weld marks 410 as the drum 400 rotates.

### DETAILED DESCRIPTION

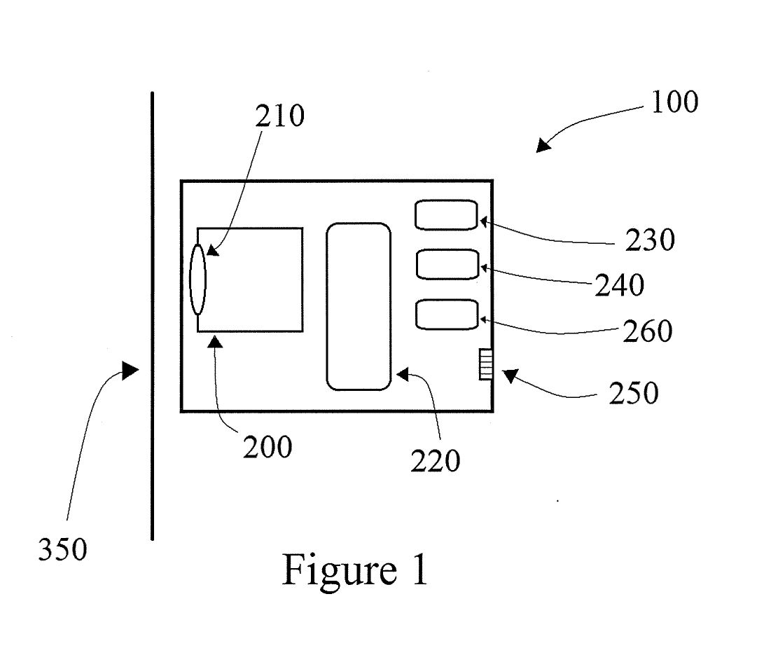

FIG. 1 is a block diagram of the components that make up a visual direction detection system 100 in a single-module embodiment. In other embodiments of the visual rotation direction detection system 100, the components may be separated from each other and packaged into multiple discrete modules. These modules may be connected by either wired or wireless communication techniques and placed in a preferred position based on the customer's needs and the arrangement of a particular ready mix truck.

The visual direction detection system 100 is mounted as illustrated in FIG. 1. The camera 200 is facing the window glass 350 at the rear of the truck cabin. A durable double sided tape or a special mount or mounting bracket may be used to secure the visual direction detection system 100 to the glass 350. Prior to mounting the system 100, the camera 200 must be properly focused to ensure the camera 200 obtains a clear image of the ready mix truck drum 400. Sealing the visual direction detection system 100 to the window glass 350 with double sided tape or another suitable sealant minimizes the chances of dust getting in to the camera 200. Certain embodiments may also comprise a housing around the camera or around the entire system designed to prevent contamination of the electronics by dust, concrete, and/or humidity. In certain embodiments, the housing my connect to the ready mix truck's air conditioning and/or heating system in order to maintain appropriate operating temperatures of the electronic components involved.

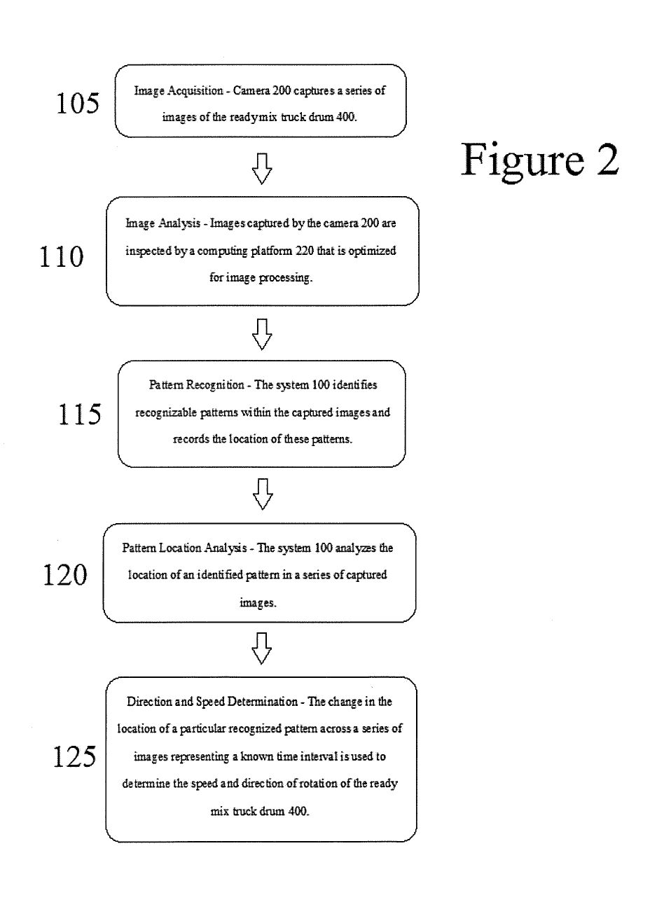

FIG. 2 is a flow diagram showing the steps 105-125 performed by a preferred embodiment of the system 100 to determine the speed and direction of rotation of the drum 400. In a first step 105, the camera 200 captures a video stream, a series of images, and/or a limited set of still images of the ready mix truck drum 400. In the next step 110, the images acquired by the camera 200 are inspected by a computing platform 220 that is optimized for image processing. The system 100 then identifies recognizable patterns within the captured images and records the location of these patterns in step 115. In some embodiments the edge points of a pattern may be identified and used to determine the location of the pattern. This process is repeated for multiple images over a known period of time. The system 100 then proceeds to analyze the location of an identified pattern across a series of captured images in step 120. In a final step 125, the change in the location of a particular recognized pattern across a series of images representing a known time interval is used to determine the speed and direction of rotation of the ready mix truck drum 400.

The required frame rate of the camera 200 depends on the speed of the rotating drum 400 and the detectable patterns on the drum 400. Acquiring a greater number of frames will help determine the direction of rotation faster and more accurately. It may be necessary to store the images on board the unit in certain customer configurations. To fulfill this goal, the visual direction detection system 100 can be equipped with an on board data storage component 230. Along with images and video, a vast array of other data points can be captured and associated with the direction and/or speed of rotation. Data points such as GPS location of the truck, time and/or date stamp, speed of the truck, operator ID, weather conditions, elapsed time since the truck was loaded and many more may be recorded. By correlating these data points with the direction of rotation of the drum, a more thorough understanding of the treatment and conditions associated with unloading ready mix concrete can be developed.

To improve precision and detect the direction of rotation faster, certain embodiments of the invention may contain an on board global positioning system (“GPS”) module 240. In instances when the drum 400 is brand new or when the truck is operating in near darkness, the GPS module 240 will help improve accuracy of the detection. The GPS module may be used to determine the location and/or speed of the truck. The algorithm may be configured to know that the truck will not unload concrete when the truck is traveling at above a predetermined speed. Certain embodiments may also be configured to know where the planned unloading site of the truck is. In some embodiments, the algorithm may be configured to understand it is more likely that the truck will be unloading when it is at or near its predetermined unloading location and less likely to unload at more remote locations.

Once the visual direction detection system 100 is mounted on the rear window 350, there may be a need to periodically calibrate the camera or upgrade the software and firmware. If this activity is done manually, it may be advantageous to have a physical interface. In some embodiments, an optional Universal Serial Bus (USB) port 250 may be added to the system 100.

When the drum rotation direction changes from charging to discharging (unloading the concrete), it is often desirable to notify the dispatch center. Depending on the embodiment of the invention used, the rotation direction data can be sent over a cellular data connection or a Wi-Fi connection. This transmission is achieved through the communication interface 260.

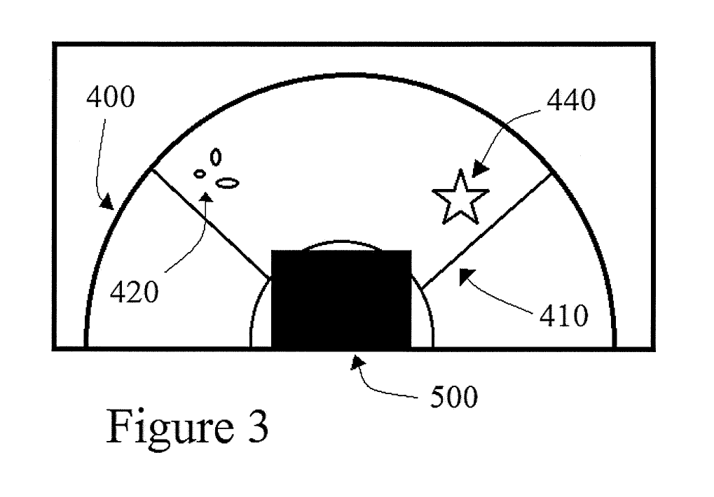

FIG. 3 illustrates a view from the rear window glass 350 in the cabin of a ready mix truck. The driver must be able to see the drum 400 for safety reasons, therefore clear glass 350 is used in ready mix trucks. Depending on the type of truck, there are typically some components that are fixed in position and create a visible obstruction 500 through the rear window of the ready mix truck cabin. The visual rotation direction detection system 100 must be positioned so that any visible obstruction 500 does not prevent the camera 200 from having a clear view of the drum 400. The system 100 works best when the weld marks 410 are clearly visible on the drum 400. The drum 400 almost always has some weld marks 410, which are necessary to manufacturing the drum 400.

The visual direction detection system 100 operates in a manner that is unique, because it does not need any equipment placed on the drum 400. The system 100 does not require any man-made markings 440 placed on the drum 400 either; however, any visible marks placed on the drum 400, such as stickers, logos and/or reflectors 440, can greatly assist the detection process as discussed below.

The illustration in FIG. 3 shows a drum 400 that is considered in excellent condition for the visual direction detection system 100. Due to the chemicals used and exposure to the environment, the steel drums 400 often start to rust leaving visible wear-and-tear marks 420 on the surface of the drum 400. Initially, there is typically discoloration and paint peeling off of the drum 400. Shortly after the paint peels off of the drum 400, rust starts to appear. These visible marks 420 can be clearly seen by the camera 200 and used by the system 100 to determine the direction of rotation. By comparing one still image captured by the camera 200 to the next, the system 100 will compare the movement of detectable visual marks 420 over a period of several images. The visible marks 420 are then normalized by the system 100 to determine a general direction of rotation. This technique may also be applicable to video streams but is most useful when applied to a series of still images.

The drum 400 is set at an angle on the chassis of the truck. The drum 400 is frequently elliptical rather than circular but the disclosed invention will operate regardless of the exact drum shape. Due to these frequently elliptical drum conditions, some of the points tracked by the system 100 will not move directly in the charging or discharging direction. The system 100 compensates for these angles and normalizes the direction of rotation to determine if the drum 400 is rotating in the charging or discharging direction. The major direction of movement of these points over a certain time period or number of image frames will increase the confidence threshold of the system.

In a new drum 400 that has fewer visual marks 420 due to wear-and-tear, the visual direction detection system 100 will detect the pattern of points on the weld marks 410. Weld marks 410 are not smooth and typically consist of many low and high relief features, which will constitute points of interest to the system 100. The direction of movement of these points is normalized by the system 100 and used to determine the direction of drum rotation.

By using the on board GPS 240, the system 100 can improve the speed and accuracy of its determination. A ready mix truck will not engage the drum 400 to discharge while the truck is traveling at significant speed. There is a possibility that the vehicle will move at a very slow speed if it has to pour a narrow path. The system 100 can compensate for this possibility and generally can assume that a vehicle traveling at a significant speed will not discharge. A GPS module 240 can be directly integrated into the system 100, or an external GPS module 240 can be plugged into the USB port 250 to provide speed and location information. This input from the GPS module 240 can improve the determination of rotation direction, especially for brand new drums 400 or when the ready mix truck is operating in low-light conditions.

Several ready mix companies place stickers or logos 440 on the drum 400 to assist the driver in determining the direction of rotation or for company branding. The presence of these stickers 440 improves the speed and accuracy of the rotation determination similar to the presence of visible marks 420 caused by rust. In both cases, the system 100 uses a visible pattern with multiple points of interest to verify its determination.

If a pattern of stickers or markers 440 is placed on a ready mix truck drum 400, that pattern can be used to determine the speed of rotation as well as the direction of rotation. The system 100 is capable of determining the approximate speed of rotation, but if the customer has no interest in determining drum rotation speed, that portion of the system 100 can be disabled. The most critical problem facing ready mix companies is to determine the moment that the concrete is discharged from the drum 400. This visual direction detection system 100 is capable of determining that moment without calculating the speed of drum rotation.

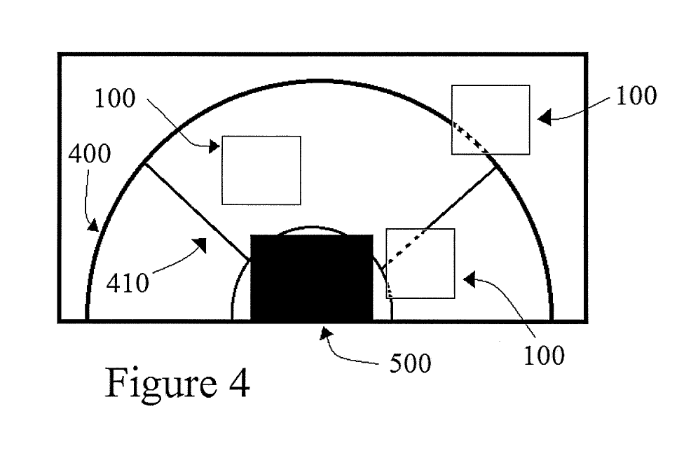

FIG. 4 illustrates some examples of where the camera 200 can be mounted on the glass 350 at the rear of the truck cabin. From a proper mounting position, the camera 200 can be focused to see the rust or discoloration marks 420, a particular logo 440, or the weld marks 410. The location of the camera 200 can be changed to achieve the optimal detection of rotation direction according to the specific layout of each ready mix truck.

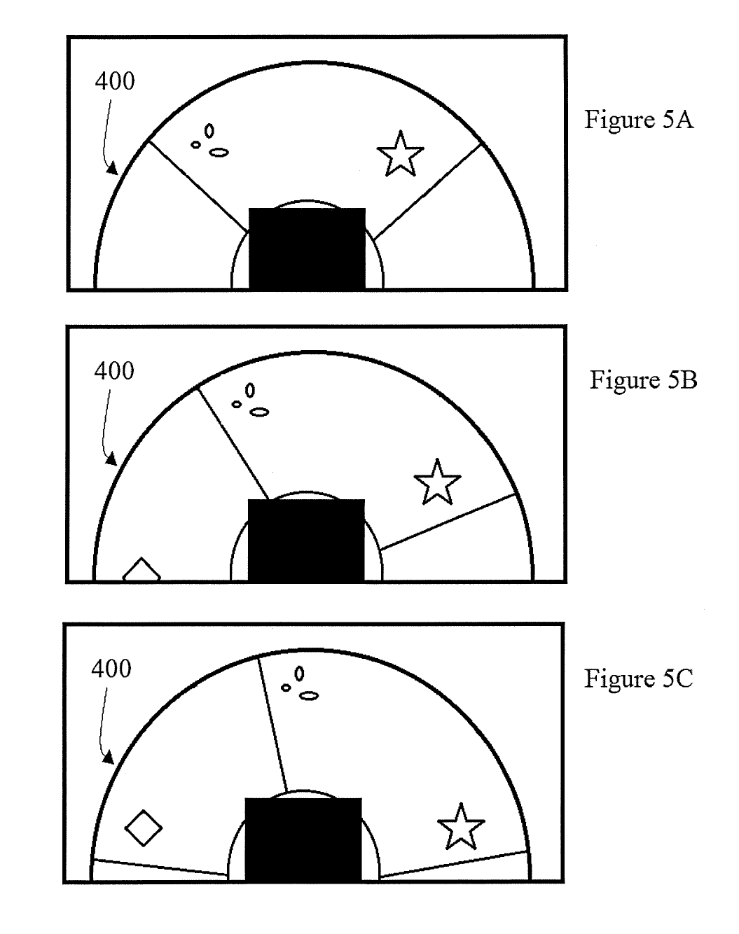

FIGS. 5A through 5C depict a series of images of a ready mix truck drum 400 as it rotates. The system 100 acquires images similar to this series and analyzes the images. The system is able to recognize the visible patterns on the drum and note their location in each image. As the series of images progresses, the location of the visible patterns changes. By comparing the location of a visible pattern across a series of images taken over a known period of time, the system 100 is able to determine both the speed and direction of drum rotation.

Multiple embodiments of the invention have been described above. The claimed subject matter is not intended to be limited in scope by the specific embodiments described herein. Indeed, various modifications of the invention in addition to those described herein will become apparent to those skilled in the art from the foregoing description. Such modifications are intended to fall within the scope of the appended claims.

What is claimed is:

1. A system for detecting the direction of rotation of a ready mix truck drum, the system comprising:
a camera operably connected to a computing platform, wherein the camera is capable of capturing images of a ready mix truck drum and the computing platform is optimized for image processing,
the camera arranged and designed to acquire a series of images of a truck drum as the truck drum rotates;
a direction determination software running on the computing platform, wherein the software is designed to identify a visual pattern contained in the images taken by the camera,
said direction determination software arranged and designed to determine the direction of rotation of a ready mix truck drum based on differences in the images acquired by the camera over a period of time; and,
a communication interface operably connected to the computing platform, wherein the communication interface is arranged and designed to communicate the direction of rotation determined by the software to a ready mix operator.

2. The system of claim 1, wherein the software is designed to identify logos, reflectors or other man-made markings on the drum of the ready mix truck for use in determining the direction of rotation.

3. The system of claim 1, wherein the software is designed to identify visible patterns of rust or discoloration on the drum of the ready mix truck for use in determining the direction of rotation.

4. The system of claim 1, wherein the software is designed to identify welding marks on the ready mix truck drum for use in determining the direction of rotation.

5. The system of claim 1, wherein the system further comprises a ready mix truck comprising a rotating drum and a cabin with a transparent rear window.

6. The system of claim 5, wherein the camera is mounted inside the interior of a ready mix truck cabin.

7. The system of claim 5, wherein rear window is made of glass.

8. The system of claim 5, wherein the rear window is made of a transparent polymer.

9. The system of claim 5, wherein the camera is mounted in a position, such that the camera can capture an image of any material being discharged from the ready mix truck drum.

10. The system of claim 1, wherein the communication interface is arranged and designed to inform the ready mix truck operator of the time the system determines the direction of drum rotation has changed.

11. A machine vision method for determining the direction of rotation of a ready mix truck drum, the method comprising:
acquiring a series of images of a ready mix truck drum from a fixed viewing position;
inspecting the images in the sequence of images for points of interest;
determining the location of a point of interest in each image;
comparing the location of the point of interest across multiple images; and,
determining the direction of drum rotation based on the change in the location of a point of interest across multiple images.

12. The method of claim 11, further comprising the step of communicating the direction of drum rotation to a ready mix truck operator.

13. The method of claim 11, further comprising the step of recording the direction of drum rotation on a data storage component.

14. The method of claim 11, further comprising the step of recording the time when the direction of rotation changes.

15. A system for detecting the direction of rotation of a ready mix truck drum, the system comprising:
a camera operably connected to a computing platform, wherein the camera is capable of capturing images of a ready mix truck drum and the computing platform is optimized for image processing,
the camera arranged and designed to acquire a series of images of a truck drum;
a direction determination software running on the computing platform, wherein the software is designed to identify a visual pattern contained in the images taken by the camera and determine the location of the visual pattern,
said direction determination software arranged and designed to determine the direction of rotation of a ready mix truck drum based on differences in the location of the identified visual patterns in the images acquired by the camera over a period of time;
a ready mix truck comprising a rotatable drum, a cabin, and a transparent window positioned such that the rotatable drum is visible from within the interior of the cabin;
a mounting bracket for fixing the camera in position such that the camera can acquire images of the rotatable drum.

16. The system of claim 15, wherein the mounting bracket is designed to be attached to the transparent rear window.

17. The system of claim 16, further comprising a housing arranged and designed to prevent dust contamination of the camera.

18. The system of claim 17, wherein the ready mix truck further comprises an air conditioning system and the housing is operably connected to the air conditioning system.
